(19) United States
(12) Patent Application Publication
(10) Pub. No.: US 2007/0149241 A1
(43) Pub. Date: Jun. 28, 2007

(54) Arrangement comprising communication means that can be activated

(75) Inventor: Thomas Gruber, Gols (AT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,764

(22) PCT Filed: Jan. 5, 2005
(86) PCT No.: PCT/IB05/50032

§ 371 Date: Jun. 23, 2006

(30) Foreign Application Priority Data
Jan. 7, 2004 (EP) 04100027.4

(51) Int. Cl. H04B 7/00

(52) U.S. Cl. 455/525; 455/445

(57) ABSTRACT

An arrangement (1) comprises first communication means (COM1) for contactless communication with a cell communication station (Z1, Z2, Z3) within a cell communication range (ZA1, ZA2, ZA3) of a cellular communication system, and second communication means (COM2) which are designed, independently of the first communication means (COM1), for contactless communication with a second communication system (B1, B2). The second communication means (COM2) can be activated by means of an activation signal (AS) that can be fed thereto, wherein the arrangement (1) has activation means (2) which are designed to detect the presence of a second communication system (B1, B2) within a cell communication range (ZA1, ZA3) by evaluating communication signals (ZS1-ZS3) between the first communication means (COM1) and a cell communication station (Z1-Z3) and, if the presence of the second communication system (B1, B2) is detected, to output the activation signal (AS) to the second communication means (COM2).

The invention relates to an arrangement comprising first communication means, which first communication means are designed for contactless communication with a cell communication station within an allocated cell communication range of a cellular communication system, and comprising second communication means which are designed, independently of the first communication means, for contactless communication with a second communication system, wherein the second communication means are designed to be activatable by means of an activation signal that can be fed thereto.

The invention furthermore relates to a cellular communication system which has at least two cell communication stations, which communication stations are each allocated a cell communication range and which communication stations are designed for contactless communication with at least one mobile arrangement within their communication range, which arrangement has first communication means for communication with the cellular communication system and second communication means, which second communication means are designed, independently of the first communication means, for contactless communication with a second communication system.

The invention furthermore relates to a communication method for contactless communication via first communication means with a cell communication station within a cell communication range of a cellular communication system, and for contactless communication via second communication means with a second communication system, wherein the first communication means and the second communication means are independent of one another.

The invention furthermore relates to a method of operating a cellular communication system which has at least two cell communication stations, which communication stations are each allocated a cell communication range and which communication stations are designed for contactless communication with at least one mobile arrangement within their communication range, which arrangement has first communication means for communication with the cellular communication system and second communication means, which second communication means are designed, independently of the first communication means, for contactless communication with a second communication system.

Document US 2003/0050103 A1 discloses a system for controlling the energy consumption of a first communication interface of an arrangement which is designed for communication with a first external wireless LAN. The system comprises a so-called power supply activator which is disposed outside the arrangement and transmits a power supply trigger signal to the arrangement when the wireless LAN wishes to communicate with the arrangement via the first communication interface. The arrangement also comprises a second communication interface which receives the power supply trigger signals. Also provided in the arrangement is a power supply management module which isolates the first communication interface from the power supply when it detects that the first communication interface is no longer required. When the power supply management module receives the power supply trigger signal from the second communication interface, it switches the first communication interface on again.

In this known arrangement, it has proven to be disadvantageous that the second communication interface and the power supply activator are present only for the purposes of receiving and processing a power supply trigger signal and in turn consume energy and moreover are redundant modules since communication takes place between the wireless LAN and the arrangement via the first communication interface. Furthermore, the power supply activator is disposed externally with respect to the arrangement, and this makes the system more complicated.

It is an object of the invention to provide an arrangement of the type mentioned in the first paragraph, a cellular communication system of the type mentioned in the second paragraph, a communication method of the type mentioned in the third paragraph and a method of operating a cellular communication system of the type mentioned in the fourth paragraph, in which the above-described disadvantages are avoided.

In order to achieve the abovementioned object, features according to the invention are provided in an arrangement according to the invention so that an arrangement according to the invention can be characterized as follows, namely:

An arrangement comprising first communication means, which first communication means are designed for contactless communication with a cell communication station within an allocated cell communication range of a cellular communication system, and comprising second communication means which are designed, independently of the first communication means, for contactless communication with a second communication system, wherein the second communication means are designed to be activatable by means of an activation signal that can be fed thereto, and comprising activation means, which activation means are designed to detect the presence of a second communication system within a cell communication range by evaluating communication signals between the first communication means and a cell communication station and, if the presence of the second communication system is detected, to output the activation signal to the second communication means.

In order to achieve the abovementioned object, features according to the invention are provided in a cellular communication system according to the invention so that a cellular communication system according to the invention can be characterized as follows, namely:

A cellular communication system which has at least two cell communication stations, which communication stations are each allocated a cell communication range and which communication stations are designed for contactless communication with at least one mobile arrangement within their communication range, which arrangement has first communication means for communication with the cellular communication system and second communication means, which second communication means are designed, independently of the first communication means, for contactless communication with a second communication system, wherein the cellular communication system is designed to transmit a trigger signal, which trigger signal can be used to trigger activation of the second communication means, to the mobile arrangement, which arrangement is located in predefined cell communication ranges, for which cell communication ranges in the cellular communication system the transmission of the trigger signal is preset.

In order to achieve the abovementioned object, features according to the invention are provided in a communication method according to the invention so that a communication method according to the invention can be characterized as follows, namely:

A communication method for contactless communication via first communication means with a cell communication station within a cell communication range of a cellular communication system, and for contactless communication via second communication means with a second communication system, wherein the first communication means and the second communication means are independent of one another, which method comprises the following method steps, namely:

detecting the presence of a second communication system within a cell communication range by evaluating communication signals between the first communication means and the cell communication station and

activating the second communication means if the presence of the second communication system has been detected within the cell communication range.

In order to achieve the abovementioned object, features according to the invention are provided in a method according to the invention for operating a cellular communication system, so that a method according to the invention for operating a cellular communication system can be characterized as follows, namely:

A method of operating a cellular communication system which has at least two cell communication stations, which communication stations are each allocated a cell communication range and which communication stations are designed for contactless communication with at least one mobile arrangement within their communication range, which arrangement has first communication means for communication with the cellular communication system and second communication means, which second communication means are designed, independently of the first communication means, for contactless communication with a second communication system, said method comprising the transmission of a trigger signal, which trigger signal can be used to trigger activation of the second communication means, to the mobile arrangement, which arrangement is located in predefined cell communication ranges, for which communication ranges in the cellular communication system the transmission of the trigger signal is preset.

By virtue of the features according to the invention, optimum use is made of synergy effects in that information transmitted via a first communication channel provided for voice or data communication, namely the communication link between the first communication means of the arrangement and the cellular communication system, is used to switch the second communication means on or off. Compared to the prior art, there is thus no need for any redundant and power-consuming components since the invention can be implemented for example by relatively simple adaptation of the software of the arrangement. The hardware costs of the arrangement according to the invention also remain low since redundant components are avoided. Furthermore, optimal power consumption management of the arrangement according to the invention is achieved by virtue of the features according to the invention.

It may be mentioned that document JP 2002-290308 discloses a mobile telephone with Bluetooth communication means which are automatically deactivated when the mobile telephone is taken out of the range of action of a Bluetooth piconet. The mobile telephone is equipped with a GPS module for accurately determining the position of the mobile telephone. A CPU of the mobile telephone uses position data supplied by the GPS module to record positions or regions in which the Bluetooth communication is to be activated. The GPS module is in turn designed to deactivate the Bluetooth communication if the current position differs from the stored position data. In this known mobile telephone, there is also the problem that the GPS module used to deactivate the Bluetooth communication itself consumes a considerable amount of power and is moreover expensive. Furthermore, in some circumstances the stored position data define too small a Bluetooth location range, so that the Bluetooth function remains or becomes deactivated even though it could actually be used.

Some embodiments of the invention, wherein among other features the activation means are designed to detect a cell identifier, offer the advantage that, for the purpose of detecting whether the second communication is available, with the cell identifier an information item is used which is made available as standard in the first cellular communication system. No change or supplement to the first communication system is thus necessary in order to implement the invention.

Further embodiments of the invention, wherein among other features the activation means are designed to output the activation signal, offer the advantage that, even if the list of predefined cell identifiers indicating the presence of a second communication system is not up-to-date or contains errors, an attempt is automatically made to make contact with a second communication system which may be present in the vicinity of the arrangement. For example, the activation signal may be output each time the arrangement is transported from one cell communication range to another cell communication range. Since the respective cell communication ranges need not always correspond to the range of action of the second communication system, it may also happen that although the previously stored cell identifiers are correct, no connection between the second communication means of the arrangement and the second communication system can be set up. In such a case, too, it may be useful to output an activation signal at regular intervals in order to activate the second communication means and thereby check whether it is possible to make contact with the second communication system. Should this test not be successful, the second communication means may be automatically switched off after a short time.

Still further embodiments offer the advantage that the list of predefined cell identifiers indicating the presence of a second communication system is updated automatically.

Further embodiments, wherein among other features the activation means are designed to obtain cell identifiers, offer the advantage that the list of predefined cell identifiers indicating the presence of a second communication system can be updated in a user-controlled manner by accessing remote databases, for example via the Internet or via one of the two available communication systems. Such databases may be divided for example into geographical areas or provide additional information about the type and functions of the second communication system.

Further embodiments, wherein among other features the activation means are designed to store cell identifiers, offer the advantage that the user of the arrangement can himself update the cell identifiers indicating the presence of a second communication system, wherein he need only press a key on the arrangement or select an entry in an operating menu for example.

Further embodiments, wherein among other features the activation means are designed to detect a trigger signal, offer the advantage that the provider of the first communication system may offer value-added services by operating second communication systems in some regions or indicating the presence thereof. For example, Bluetooth communication services may be provided as second communication system in trains and the provider of the first communication system provides all the suitable or selected arrangements in the cell communication ranges along the track with the trigger signal and thereby makes the second communication means contained in these arrangements remain switched on or become activated.

The abovementioned aspects and further aspects of the invention emerge from the example of embodiment described below and are explained with reference to this example of embodiment.

The invention will be further described with reference to an example of embodiment shown in the drawings to which, however, the invention is not restricted.

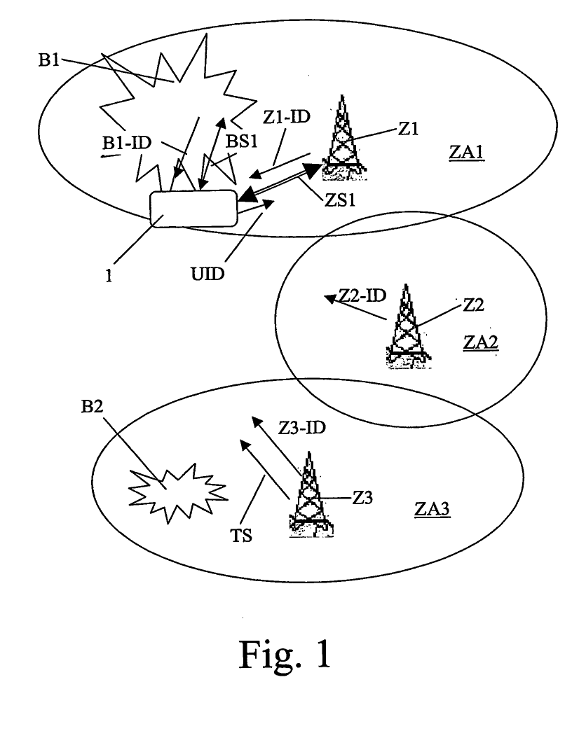

FIG. 1 schematically shows a cellular communication system, in the cell communication range of which there is an arrangement according to the invention, and the location of two communication systems in the cell communication ranges.

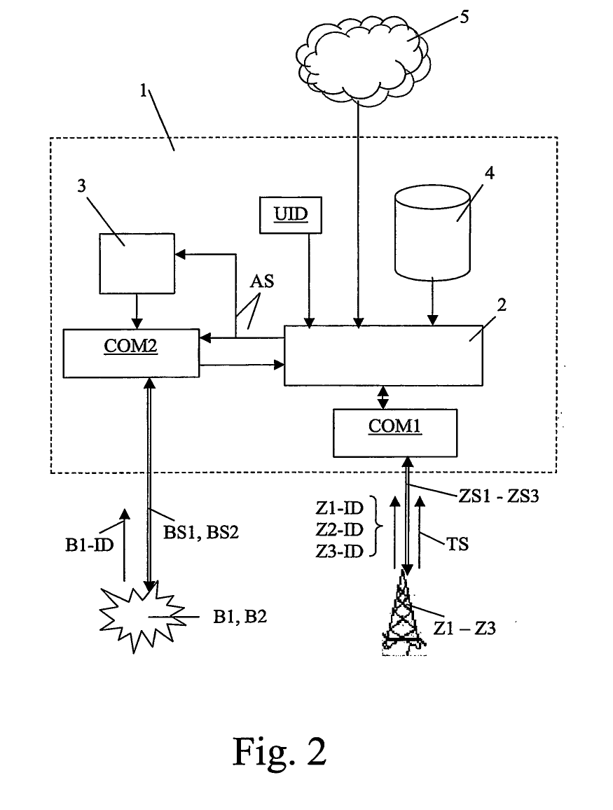

FIG. 2 shows a block diagram of an arrangement according to the invention with two communication means which are independent of one another.

FIG. 1 symbolically shows the topology of a wireless cellular communication system which in the present case comprises three cell communication stations Z1, Z2, Z3, wherein the transmitting and receiving range of each cell communication station Z1, Z2, Z3 defines a cell communication range ZA1, ZA2, ZA3. The cellular communication system is in the present case designed as a GSM mobile telephone system, in which case the cell communication stations Z1 to Z3 communicate with a base station controller (not shown) which is in turn connected to a switching station, as is known from the GSM standard. However, it should be mentioned that there may also be provided as cellular communication system for example the UMTS mobile telephone or a mobile radio system based on cellular communication, as used for example in military or civil vehicles.

Each cell communication station Z1, Z2, Z3 can communicate within its cell communication range ZA1, ZA2, ZA3 with at least one mobile arrangement 1 which has first communication means (COM1) for communication with the cellular communication system. In the present case, the mobile arrangement 1 is formed by a mobile telephone. However, it should be mentioned that the arrangements 1 may also be designed as a Personal Digital Assistant (PDA), a notebook or a radio, etc. The block diagram of an arrangement 1 is shown in FIG. 2, wherein functional blocks of the arrangement which do not directly relate to the invention have been omitted for reasons of clarity.

Using their subscriber identifier UID, the arrangements 1 report to that cell communication station Z1, Z2 or Z3 within whose cell communication range ZA1, ZA2 or ZA3 they are located, as a result of which wireless communication between the arrangement 1 and the corresponding cell communication station Z1, Z2, Z3 is initiated. By virtue of the subscriber identifier UID, each arrangement 1 can be unambiguously identified by the cellular communication system. Once communication has been initiated, telephone conversations for example can be switched to the arrangement 1 by the cell communication system.

It should be mentioned that data traffic takes place between the arrangement I and the cell communication stations Z1, Z2 or Z3 even at those times at which a user of the arrangement I is not actively using the first communication means COM1 of the arrangement 1, that is to say is not making a telephone call. Thus, the first communication means COM1 report at regular intervals to the cell communication station in whose cell communication range they are located. It should furthermore be mentioned that the cell communication stations Z1-Z3 transmit to the mobile arrangement 1 cell identifiers Z1-ID, Z2-ID, Z3-ID contained in communication signals ZS1-ZS3, so that the arrangement 1 is always informed with regard to with which cell communication station Z1, Z2 or Z3 it has to communicate. Since the cell communication stations Z1, Z2 or Z3 are fixed, the geographical position of their cell communication range can be derived from their cell identifiers.

The arrangement 1 furthermore has second communication means COM2 which are designed, independently of the first communication means COM1, for contactless communication with a second communication system B1, B2. The second communication system is in the present case formed as a Bluetooth system. However, it may also be formed by a wireless LAN (WLAN) or some other communication system. The second communication system is also fixed, so that it has a defined spatial transmitting and receiving range, for example in the form of a so-called hot-spot or piconet. Spatial association between a respective second communication system B1, B2 and a cell communication range ZA1-ZA3 of the first communication system is thus possible. It should be mentioned that the range of action of a second communication system B1, B2 need not correspond exactly to the cells communication ranges ZA1 and ZA2 of the first communication system or be the same size as the latter. For example, FIG. 1 shows a second communication system B1 which lies within the cell communication range ZA1 but has a smaller range of action. In a similar manner, another second communication system B2 lies within the cell communication range ZA3 whereas there is no second communication system in the cell communication range ZA2.

As can be seen from FIG. 1, the second communication means COM2 of the arrangement 1 are not always in contact with a second communication system B1, B2. It is therefore desirable to switch off the power supply to the second communication means COM2 whenever there is no such contact. However, at least certain services or functions of the second communication means COM2 may be deactivated when there is no contact with a second communication system B1, B2, in order thereby to reduce the power consumption of the arrangement 1. This is because it has been found that the communication means COM2 contribute considerably to the overall power consumption of the arrangement 1, particularly when the latter is designed as a mobile telephone or PDA. By switching off the communication means COM2 or at least some of the functions or services thereof, it is possible to considerably lengthen the operating time when using an accumulator as power source for the arrangement 1.

Since, as mentioned above, there is a spatial connection between the range of action of the second communication system B1, B2 and the cell communication ranges ZA1, ZA2, ZA3 of a cellular communication system, according to the present invention this connection is used to detect when communication between the second communication means COM2 and a second communication system B1, B2 is theoretically possible, that is to say when the arrangement 1 is located within a cell communication range ZA1 or ZA3 in which a second communication system B1, B2 is also located. The term “theoretically possible” means that, even when the arrangement 1 is located within the range of action of a second communication system B1, B2, communication between the second communication means COM2 and the second communication system B1, B2 may be interrupted on account of external circumstances or a fault in the second communication system B1, B2.

According to the invention, the arrangement 1 has activation means 2 which are designed to detect the presence of a second communication system B1, B2 within a cell communication range ZA1, ZA3 by evaluating the communication signals ZS1-ZS3 between the first communication means COM1 of the arrangement 1 and a cell communication station Z1-Z3 of the cellular communication system such that the current cell communication range in which the arrangement 1 is located is determined there from and, in turn, it is determined whether there is a second communication system B1, B2 within this cell communication range ZA1-ZA3. If the evaluation shows that at the present position of the arrangement 1 contact with a second communication system B1, B2 would be possible, the activation means 2 output an activation signal AS directly to the second communication means COM2 or to a power supply unit 3 for the second communication means, as a result of which the second communication means COM2 or functions or services thereof are activated. Deactivation of the second communication means COM2 may be automatically brought about by the latter, for example if no communication takes place between the second communication means COM2 and the second communication system B1, B2 for a certain length of time. Alternatively, the activation means 2 may also be designed to deactivate the second communication means COM2, for example when the arrangement 1 is transported into a cell communication range ZA2 in which there is no second communication system.

In one embodiment of the invention, the activation means 2 are designed to determine, from the cell identifier Z1-ID, Z2-ID, Z3-ID supplied by the corresponding cell communication station Z1-Z3, the presence of a second communication system B1, B2 in that cell communication range ZA1 or ZA3 in which the arrangement I is already located. As mentioned above, the cell identifiers Z1-ID, Z2-ID, Z3-ID are transmitted within the communication signals ZS1-ZS3 to the first communication means COM1. The current cell identifier, that is to say the cell identifier Z1-ID in the example of FIG. 1, is compared by the activation means 2 with cell identifiers Z1-ID and Z2-ID stored in cell identifier storage means 4 of the arrangement 1. If the comparison shows that they correspond, the activation signal AS is output by the activation means 2.

Storage of the cell identifiers Z1-ID and Z2-ID indicating the presence of a second communication system B1, B2 in the cell identifier storage means 4 may be effected in two ways.

Firstly, as in the present case, a user of the arrangement 1 may cause the activation means 2 of the arrangement 1 to store the current cell identifier Z1 -ID or Z2-ID in the cell identifier storage means 4 when he finds himself with the arrangement l at a position in which communication between the second communication means COM2 of the arrangement 1 and a second communication system B1, B2 is possible. For this purpose, in one embodiment of the invention he need only press a key on the arrangement 1 or select a corresponding menu item in an operating menu of the arrangement 1. Possibly a communication system identifier B1-ID or B2-ID may also be stored in the cell identifier storage means 4 together with the cell identifier Z1-ID or Z2-ID, which communication system identifier is supplied by the second communication system B1 or B2 and provides further details regarding the type or function of the second communication system.

As an alternative to manually storing cell identifiers Z1-ID to Z3-ID in the cell identifier storage means 4, the activation means 2 of the arrangement 1 may also be designed to obtain cell identifiers Z1-ID, Z3-ID indicating the presence of a second communication system B1, B2, possibly together with a communication system identifier B1-ID or B2-ID representative of the second communication system B1, B2, by accessing a remote database 5 and to store them in the cell identifier storage means 4. The database 5 may be designed as an Internet database, in which case there are business opportunities for operators of the first or second communication system to provide access to this database 5 in return for payment.

In the case where the cell identifiers stored in the cell identifier storage means 4 have become obsolete, according to one development of the invention the activation means 2 may be designed such that they output the activation signal AS at least briefly when the cell identifier Z2-ID detected from the communication signals ZS2 does not correspond to any of the cell identifiers Z1-ID or Z3-ID previously stored in the cell identifier storage means 4. In this way, the second communication means COM2 are able themselves to search for the presence of a second communication system B1 or B2. If this leads to contact being made between the communication means COM2 and a second communication system B1, B2, the current cell identifier Zi-ID is stored by the activation means 2 in the cell identifier storage means 4.

In one variant of this embodiment of the invention, the activation means 2 always store the current cell identifier Zi-ID when communication signals BSi are exchanged between the second communication means COM2 and the second communication system Bi. In this embodiment of the invention, the cell identifier storage means 4 are thus updated automatically.

In yet another embodiment of the invention, the activation means 2 are designed to detect a trigger signal TS from the communication signals ZS1-ZS3 and to output the activation signal AS when the trigger signal TS is detected. In this embodiment, the cellular communication system must be designed such that it transmits the necessary trigger signal TS, by means of the communication signals ZS1 or ZS2, to each mobile arrangement 1 which is located in a predefined cell communication range ZA1 or ZA3 for which in the cellular communication system transmission of the trigger signal TS is preset because a second communication system B1 or B2 is present there. Transmission of the trigger signal TS may be effected as a function of the subscriber identifier UID of the mobile arrangement 1, which is known to the cellular communication system. Transmission of the trigger signal TS may also be offered by providers of cellular communication systems as a paid-for value-added service in addition to the normal communication services.

Finally, the essential functions of a mobile arrangement according to the invention will be summarized once more on the basis of a scheme not shown in the Figures. Following switch-on of the arrangement 1, in which a mobile telephone function is formed by first communication means COM1 and in which a Bluetooth function is formed by second communication means COM2, the arrangement 1 identifies itself to the cellular communication system via the first communication means COM1 by transmitting its subscriber identifier UID. In turn, the cellular communication system sends back the cell identifier Z1-ID to Z3-ID of that cell communication station Z1 to Z3 in whose cell communication range ZA1 to ZA3 the arrangement 1 is located. If the cell identifier Z1-ID to Z3-ID of the arrangement 1 is known, that is to say if it is stored in its cell identifier storage means 4, a check is made in the arrangement 1 as to whether the cell identifier Z1-ID to Z3-ID is assigned to activating (or possibly also deactivating) certain functions or services of the arrangement, in particular the switching on/off of the second communication means COM2. If this is the case, the associated functions or services are activated (deactivated). If this is not the case, no specific action is required. If the cell identifier Zi-ID obtained from the arrangement 1 is unknown, the activation or deactivation of certain functions or services of the arrangement 1, in particular the switching on/off of the second communication means, can be assigned to this cell identifier Zi-ID by the user of the arrangement 1, for example via user menu control.

Although in the example of embodiment above the basis used was always an arrangement 1 in which a subscriber identifier UID that can be output to the cellular communication system is stored, it should be mentioned at this point that an identifier for identifying a subscriber or the arrangement 1 itself may also be generated dynamically when communication with the communication system is set up. It should furthermore be mentioned that it is also possible for there to be no subscriber identifier at all.

It should be mentioned that the term functions and services may refer for example to a synchronization process between data contained in the arrangement 1 and data not contained in the arrangement 1, which data may relate for example to so-called “stock news” or general “news tickers”. Furthermore, the term may also be understood to include the free or paid-for provision of a wireless LAN device or Bluetooth device, such as for example a printer or a monitor or an audio and/or video signal source and/or sink.

1. An arrangement (1) comprising:
first communication means (COM1), which first communication means (COM1) are designed for contactless communication with a cell communication station (Z1, Z2, Z3) within an allocated cell communication range (ZA1, ZA2, ZA3) of a cellular communication system, and
second communication means (COM2) which are designed, independently of the first communication means (COM1), for contactless communication with a second communication system (B1, B2), wherein the second communication means (COM2) are designed to be activatable by means of an activation signal (AS) that can be fed thereto, and
activation means (2), which are designed to detect the presence of a second communication system (B1, B2) within a cell communication range (ZA1, ZA3) by evaluating communication signals (ZS1-ZS3) between the first communication means (COM1) and a cell communication station (Z1-Z3) and, if the presence of the second communication system (B1, B2) is detected, to output the activation signal (AS) to the second communication means (COM2).

2. An arrangement as claimed in claim 1, wherein the activation means (2) are designed to detect a cell identifier (Z1-ID, Z2-ID, Z3-ID) contained in the communication signals (ZS1-ZS3) and to compare the detected cell identifier (Z1-ID, Z2-ID, Z3-ID) with cell identifiers (Z1-ID, Z3-ID) which are stored in cell identifier storage means (4) of the arrangement (1) and indicate the presence of a second communication system (B1, B2) and, if the detected cell identifier (Z1-ID, Z2-ID, Z3-ID) corresponds to one of the stored cell identifiers (Z1-ID, Z3-ID), to output the activation signal (AS).

3. An arrangement as claimed in claim 2, wherein the activation means (2) are designed to output the activation signal (AS) in a time-limited manner if the cell identifier (Z2-ID) detected from the communication signals does not correspond to any of the cell identifiers (Z1-ID, Z3-ID) previously stored in the cell identifier storage means (4).

4. An arrangement as claimed in claim 2, wherein the activation means (2) are designed, if communication signals (BS1) are ascertained between the second communication means (COM2) and the second communication system (B1), to store the current detected cell identifier (Z1-ID) in the cell identifier storage means (4), preferably together with a communication system identifier (B1-ID) representative of the second communication system (B1).

5. An arrangement as claimed in claim 2, wherein the activation means (2) are designed to obtain cell identifiers (Z1-ID, Z3-ID) indicating the presence of a second communication system (B1, B2), possibly together with a communication system identifier (B1-ID) representative of the second communication system, by accessing a remote database (5), and to store these in the cell identifier storage means (4).

6. An arrangement as claimed in claim 2, wherein the activation means (2) are designed to store cell identifiers (Z1-ID, Z3-ID) indicating the presence of a second communication system in the cell identifier storage means (4) as a function of instructions from a user of the arrangement (1).

7. An arrangement as claimed in claim 1, wherein the activation means (2) are designed to detect a trigger signal (TS) in the communication signals (ZS1-ZS3), which trigger signal (TS) can be used to trigger activation of the second communication means (COM2), and to output the activation signal (AS) when the trigger signal (TS) is detected.

8. A cellular communication system which has at least two cell communication stations (Z1-Z3), which communication stations (Z1-Z3) are each allocated a cell communication range (ZA1-ZA3) and which communication stations (Z1-Z3) are designed for contactless communication with at least one mobile arrangement (1) within their communication range (ZA1-ZA3), which arrangement (1) has first communication means (COM1) for communication with the cellular communication system and second communication means (COM2), which second communication means (COM2) are designed, independently of the first communication means, for contactless communication with a second communication system (B1, B2), wherein the cellular communication system is designed to transmit a trigger signal (TS), which trigger signal (TS) can be used to trigger activation of the second communication means (COM2), to the mobile arrangement (1), which arrangement (1) is located in predefined cell communication ranges (ZA1, ZA3), for which cell communication ranges (ZA1, ZA3) in the cellular communication system the transmission of the trigger signal (TS) is preset.

9. A communication method for contactless communication via first communication means (COM1) with a cell communication station (Z1-Z3) within a cell communication range (ZA1 - ZA3) of a cellular communication system, and for contactless communication via second communication means (COM2) with a second communication system (B1, B2), wherein the first communication means and the second communication means are independent of one another, which method comprises the steps of:
detecting the presence of a second communication system (B1, B2) within a cell communication range (ZA1, ZA3) by evaluating communication signals (ZS1-ZS3) between the first communication means (COM1) and the cell communication station (Z1-Z3) and
activating the second communication means (COM2) if the presence of the second communication system (B1, B2) has been detected within the cell communication range (ZA1, ZA3).

10. A communication method as claimed in claim 9, wherein the evaluation of communication signals (ZS1-ZS3) between the first communication means (COM1) and the cell communication station (Z1-Z3) comprises detecting a cell identifier (Z1-ID, Z2-ID, Z3-ID) contained in the communication signals (ZS1-ZS3) and comparing the detected cell identifier (Z1-ID, Z2-ID, Z3-ID) with predefined cell identifiers (Z1-ID, Z3-ID) that indicate the presence of a second communication system (B1, B2).

11. A communication method as claimed in claim 10, wherein the second communication means (COM2) are kept active in a time-limited manner when the cell identifier (Z2-ID) detected from the communication signals does not correspond to any of the predefined cell identifiers (Z1-ID, Z3-ID).

12. A communication method as claimed in claim 10, wherein if communication signals (BS1) are ascertained between the second communication means (COM2) and the second communication system (B1), the current detected cell identifier (Z1-ID) is defined and stored as the presence of a second communication system, preferably together with a communication system identifier (B1-ID) representative of the second communication system.

13. A communication method as claimed in claim 10, wherein the predefined cell identifiers (Z1-ID, Z3-ID) indicating the presence of a second communication system are obtained, possibly together with a communication system identifier (B1-ID) representative of the second communication system, by accessing a remote database (5).

14. A communication method as claimed in claim 10, wherein cell identifiers (Z1-ID, Z2-ID) indicating the presence of a second communication system are stored for subsequent use as a function of instructions from a user.

15. A communication method as claimed in claim 9, wherein the evaluation of communication signals (ZS1-ZS3) between the first communication means (COM1) and the cell communication station (Z1-Z3) comprises detecting a trigger signal (TS) in the communication signals, which trigger signal (TS) can be used to trigger activation of the second communication means (COM2).

16. A method of operating a cellular communication system which has at least two cell communication stations (Z1-Z3), which communication stations (Z1-Z3) are each allocated a cell communication range (ZA1-ZA3) and which communication stations (Z1-Z3) are designed for contactless communication with at least one mobile arrangement (1) within their communication range (ZA1-ZA3), which arrangement (1) has first communication means (COM1) for communication with the cellular communication system and second communication means (COM2), which second communication means (COM2) are designed, independently of the first communication means, for contactless communication with a second communication system (B1, B2), said method comprising transmitting a trigger signal (TS), which trigger signal (TS) can be used to trigger activation of the second communication means (COM2), to the mobile arrangement (1), which arrangement (1) is located in predefined cell communication ranges (ZA1, ZA3), for which communication ranges (ZA1, ZA3) in the cellular communication system the transmission of the trigger signal (TS) is preset.
